(19) United States
(12) Patent Application Publication
(10) Pub. No.: US 2024/0303138 A1
(43) Pub. Date: Sep. 12, 2024

(54) METHOD AND SYSTEM FOR PARALLELLY PROCESSING CALL LIST ASSOCIATED WITH ARTIFICIAL INTELLIGENCE CALCULATION

(71) Applicant: MOREH CORP, Seoul (KR)

(72) Inventors: Gangwon Jo, Seoul (KR); Jungho Park, Seoul (KR)

(21) Appl. No.: 18/422,655

(22) Filed: Jan. 25, 2024

(30) Foreign Application Priority Data
Mar. 6, 2023 (KR) 10-2023-0029483
Jul. 5, 2023 (KR) 10-2023-0087164

(51) Int. Cl. G06F 9/54

(52) U.S. Cl. CPC G06F 9/542

(57) ABSTRACT

Provided is a method for parallelly processing a call list associated with an artificial intelligence calculation performed by one or more processors, including acquiring an original call list including a plurality of primitive operations, determining a number of accelerators to parallelly process the original call list, creating a plurality of sub call lists based on the determined number of accelerators and the original call list, and transmitting each of the created plurality of sub call lists to each of a plurality of accelerators corresponding to the determined number.

### CROSS-REFERENCE TO RELATED APPLICATIONS

This application claims priority under 35 U.S.C § 119 to Korean Patent Application No. 10-2023-0029483, filed in the Korean Intellectual Property Office on Mar. 6, 2023 and No. 10-2023-087164, filed in the Korean Intellectual Property Office on Jul. 5, 2023, the entire contents of which are hereby incorporated by reference.

### TECHNICAL FIELD

The present disclosure relates to a method for parallelly processing a call list associated with an artificial intelligence calculation, and specifically, to a method and system for dividing a call list into a plurality of call lists and parallelly processing the same such that primitive operations can be parallelly executed through a plurality of accelerators.

### BACKGROUND

A computing system including mass storage resources capable of simultaneously processing complex artificial intelligence calculations is built, and various types of artificial intelligence calculations are simultaneously processed through such a computing system. The computing system including mass storage resources may include a plurality of servers and a plurality of accelerators.

When executing an artificial intelligence-related program, a plurality of accelerators included in the computing system may be used. Using a plurality of accelerators for performing parallel processing on the artificial intelligence-related program, it is possible to perform calculations more quickly.

Accordingly, there is a demand for a technology for distributing a plurality of operations associated with an artificial intelligence program to a plurality of accelerators and parallelly processing artificial intelligence-related calculations.

### SUMMARY

In order to solve the problems described above, the present disclosure provides a method, a computer program stored in a computer readable recording medium, a computer readable recording medium, and an apparatus (system) for parallelly processing a call list associated with artificial intelligence calculation.

The present disclosure may be implemented in a variety of ways, including methods, apparatus (systems) and/or computer programs stored on computer readable storage media.

A method for parallelly processing a call list associated with an artificial intelligence calculation is provided, which may be performed by one or more processors and include acquiring an original call list including a plurality of primitive operations, determining a number of accelerators to parallelly process the original call list, creating a plurality of sub call lists based on the determined number of accelerators and the original call list, and transmitting each of the created plurality of sub call lists to each of a plurality of accelerators corresponding to the determined number.

In addition, the creating the plurality of sub call lists may include dividing input data included in the original call list into a plurality of pieces of sub input data based on the determined number of accelerators, and creating the plurality of sub call lists such that each of the divided plurality of sub input data is included in each of the plurality of sub call lists.

In addition, the creating the plurality of sub call lists may include inserting, into each of the plurality of sub call lists, a command for transmitting a calculation result obtained based on each of the plurality of sub call lists to a predetermined specific accelerator, in which the specific accelerator may be configured to receive, from each of the plurality of accelerators, the calculated result obtained based on each of the plurality of sub call lists, and create output data associated with the original call list based on the calculation result received from each of the plurality of accelerators.

In addition, the creating the plurality of sub-call lists may include creating a plurality of sub call lists such that the plurality of sub call lists are pipelined.

In addition, the plurality of sub call lists may include a first sub call list and a second sub call list, and in which the creating the plurality of sub call lists may include inserting, into at least one of the first sub call list or the second sub call list, a command for providing output data obtained based on the first sub call list as input data of a primitive operation included in the second sub call list.

In addition, the creating the plurality of sub call lists may include dividing parameter data applied to each of the primitive operations included in the original call list based on the determined number of accelerators, and creating the plurality of sub call lists such that each of the divided parameter data is included in each of the plurality of sub call lists.

In addition, the creating the plurality of sub call lists may include inserting, into each of the plurality of sub call lists, a first command for transmitting a calculation result obtained based on each of the plurality of sub call lists to a predetermined specific accelerator, and inserting, into each of the plurality of sub call lists, a second command for sharing the calculation result obtained by the determined specific accelerator with each of the plurality of accelerators.

In addition, the transmitting each of the plurality of sub call lists to each of the plurality of accelerators corresponding to the determined number may include determining a plurality of accelerators to which each of the plurality of sub call lists is to be transmitted, based on the position of each accelerator included in the accelerator position information.

In addition, the determining the plurality of accelerators may include determining, based on the position of each the accelerator included in the accelerator position information, whether a node including the determined number or more of accelerators is searched, and if a node including the determined number or more of accelerators is searched, determining, from among all accelerators included in the searched nodes, the plurality of accelerators to which each of the plurality of sub call lists is to be transmitted.

In addition, the method may further include, if it is determined that a node including the determined number or more of accelerators is not searched, determining a plurality of accelerators to which each of the plurality of sub call lists is to be transmitted such that each of the plurality of accelerators is included in each of a plurality of adjacent nodes.

In addition, the acquiring the original call list may include acquiring a trace from a source program including an artificial intelligence calculation, wherein the trace includes at least one of code or primitive operation associated with the source program, and acquiring an original call list based on the trace, in which the plurality of primitive operations may be included in an operation library accessible to each of the plurality of accelerators.

In addition, the acquiring the trace may include acquiring at least one of the code or primitive operation associated with the artificial intelligence calculation by executing the source program, and acquiring the trace including the acquired at least one code or primitive operations.

A computer-readable non-transitory recording medium recording instructions for executing, on a computer, the method described above may be provided.

An information processing system is provided, which may include a memory, and one or more processors connected to the memory and configured to execute one or more computer-readable programs included in the memory, in which the one or more programs may include instructions for acquiring an original call list including a plurality of primitive operations, determining a number of accelerators to parallelly process the original call list, creating a plurality of sub call lists based on the determined number of accelerators and the original call list, and transmitting each of the created plurality of sub call lists to each of a plurality of accelerators corresponding to the determined number.

According to some examples of the present disclosure, the call lists including a plurality of primitive operations associated with the artificial intelligence calculation may be parallelly processed through a plurality of accelerators. Accordingly, calculation results can be quickly acquired.

According to some examples of the present disclosure, a plurality of accelerators to parallelly process may be determined based on the respective positions of the plurality of accelerators, and a plurality of sub call lists may be transmitted to the determined plurality of accelerators. Accordingly, a communication delay between the accelerators, which occurs when the calculation results based on the sub call lists are shared, can be minimized.

According to some examples of the present disclosure, an original call list including a plurality of primitive operations can be created based on a code associated with an artificial intelligence calculation and/or a trace including primitive operations. In addition, a plurality of sub call lists based on the original call list may be created and transmitted to a plurality of accelerators. Accordingly, a plurality of primitive operations included in the call list can be normally executed in various types of accelerators without depending on the accelerator type.

The effects of the present disclosure are not limited to the effects described above, and other effects not described herein can be clearly understood by those of ordinary skill in the art (referred to as “ordinary technician”) from the description of the claims.

### BRIEF DESCRIPTION OF THE DRAWINGS

The above and other objects, features and advantages of the present disclosure will be described with reference to the accompanying drawings described below, where similar reference numerals indicate similar elements, but not limited thereto, in which:

FIG. 1 is a schematic diagram provided to explain a method for parallelly processing an original call list;

FIG. 2 is a block diagram illustrating an internal configuration of an information processing system;

FIG. 3 is a block diagram illustrating an internal configuration of a processor;

FIG. 4 illustrates an example of a trace acquired from an artificial intelligence program;

FIG. 5 illustrates an original call list;

FIG. 6 illustrates an example of a graph representation of a call list;

FIG. 7 illustrates first and second sub call lists associated with parallelization of input data;

FIG. 8 illustrates first and second sub call lists associated with pipelining;

FIG. 9 illustrates first to fourth sub call lists associated with pipelining;

FIG. 10 illustrates first and second sub call lists associated with parameter data parallel processing; and

FIG. 11 is a flowchart illustrating a method for parallelly processing a call list associated with an artificial intelligence calculation.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

A “module” or “unit” may be implemented as a processor and a memory, or may be implemented as a circuit (circuitry). The terms like “circuit” and “circuitry” refer to circuits in hardware, but the terms may also refer to circuits in software. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or marking data storage, registers, and so on. The memory is said to be in electronic communication with a processor if the processor can read information from and/or write information to the memory. The memory integrated with the processor is in electronic communication with the processor.

In the present disclosure, a “system” may refer to at least one of a server device and a cloud device, but is not limited thereto. For example, the system may include one or more server devices. In another example, the system may include one or more cloud devices. In still another example, the system may include both the server device and the cloud device operated in conjunction with each other.

In addition, terms such as first, second, A, B, (a), (b), etc. used in the following examples are only used to distinguish certain components from other components, and the nature, sequence, order, etc. of the components are not limited by the terms.

In addition, in the following examples, if a certain component is stated as being “connected,” “combined” or “coupled” to another component, it is to be understood that there may be yet another intervening component “connected,” “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

In the present disclosure, “each of a plurality of A” may refer to each of all components included in the plurality of A, or may refer to each of some of the components included in a plurality of A.

Before describing various examples of the present disclosure, terms used will be described.

In examples of the present disclosure, “artificial intelligence calculation” may refer to any calculation associated with a machine learning model (e.g., an artificial neural network model, etc.). For example, an artificial intelligence calculation may be a calculation performed in each layer included in an artificial neural network model. For example, the artificial intelligence calculation may include an addition calculation, a subtraction calculation, a maximum value computation calculation, a minimum value computation calculation, a floating point multiplication calculation, weighting calculation, convolution calculation, matrix multiplication calculation, batch normalization calculation, Rectified Linear Unit (ReLU) calculation, pooling calculation, Long Short-Term Memory (LSTM) calculation, Gated Recurrent Unit (GRU) calculation, etc. performed in a layer included in an artificial neural network model, but is not limited thereto.

The “artificial intelligence program” may herein be a source program that performs calculations associated with artificial intelligence or artificial neural network models. For example, the artificial intelligence program may be a source program associated with deep learning calculation.

The “code” may herein refer to any code prepared to execute a program, and may refer to a source code, for example. In addition, codes may be associated with instructions for calculations.

In performing the artificial intelligence calculations, a “primitive operation” may herein refer to an operation of a processor associated with basic codes and/or basic instructions. For example, the primitive operation may be included in a set of calculation operations frequently used to infer a result value in a machine learning model. For example, the primitive operation may include operations related to calculations such as addition, subtraction, maximum value calculation, minimum value calculation, floating point multiplication, convolution calculation, matrix multiplication, batch normalization, ReLU, pooling, LSTM, GRU, etc., but are not limited thereto.

A “trace” may herein include at least one code and/or at least one primitive operation associated with the artificial intelligence calculation. For example, the trace may be created by collecting calculation-related codes and/or primitive operations extracted during runtime in which an artificial intelligence program is executed. The trace may include a correlation with an execution order of each code and/or primitive operation.

An “accelerator” may herein refer to any processor or circuitry that performs artificial intelligence calculations. For example, the accelerator may refer to a processor or circuitry capable of performing artificial intelligence calculations quickly, and may include a graphics processing unit (GPU), a neural processing unit (NPU), a tensor processing unit (TPU), etc., for example, but is not limited thereto.

An “operation library” may herein be a collection or library of codes associated with a call of primitive operations. For example, the operation library may include a first code for calling a first primitive operation associated with an addition, a second code for calling a second primitive operation associated with a subtraction, a third code for calling a third primitive operation associated with a maximum value calculation, and a fourth code for calling a fourth primitive operation associated with a minimum value calculation. Additionally, the operation library may include a fifth code for calling a fifth primitive operation associated with a floating point multiplication, a sixth code for calling a sixth primitive operation associated with a convolution calculation, a seventh code for calling a seventh primitive operation associated with a matrix multiplication calculation, and an eighth code for calling an eighth primitive operation associated with a batch normalization. In addition, the operation library may include a code associated with any primitive operation.

Hereinafter, various examples of the present disclosure will be described in detail with reference to the accompanying drawings.

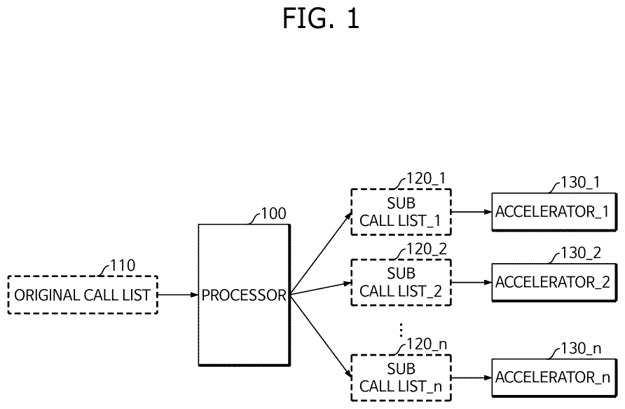

FIG. 1 is a schematic diagram provided to explain a method for parallelly processing an original call list 110. Referring to FIG. 1, a trace may be acquired while an artificial intelligence program is running. The artificial intelligence program may be a source program including an artificial intelligence calculation, and the trace may include at least one code and/or at least one primitive operation associated with the artificial intelligence calculation.

In addition, the original call list 110 may be created based on the trace. According to some examples, the trace may include a plurality of primitive operations, in which case a plurality of primitive operations may be extracted from the trace, and the original call list 110 including the extracted plurality of primitive operations may be created. The primitive operations included in the original call list 110 may not be in the binary form, but may take at least one form of a data structure, serialized data, or text in memory.

A correlation for each of the plurality of primitive operations included in the original call list 110 may be determined, and the determined correlation for each of the plurality of primitive operations may be included in the original call list 110. The correlation may herein refer to a calculation of a specific primitive operation being performed based on another primitive operation. For example, in a relationship in which output data of a first primitive operation is input to a second primitive operation, may be determined that the first primitive operation and the second primitive operation have a correlation. In addition, an execution order of each of the plurality of primitive operations included in the call list may be determined.

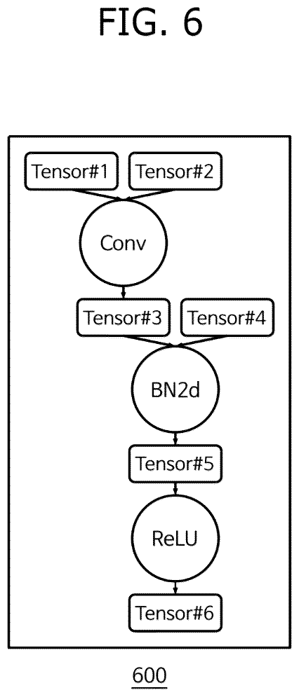

A call order and the correlation of the plurality of primitive operations may be represented in a graph form, based on the plurality of primitive operations included in the original call list 110. An example of the graph representation of the call list will be described below with reference to FIG. 6.

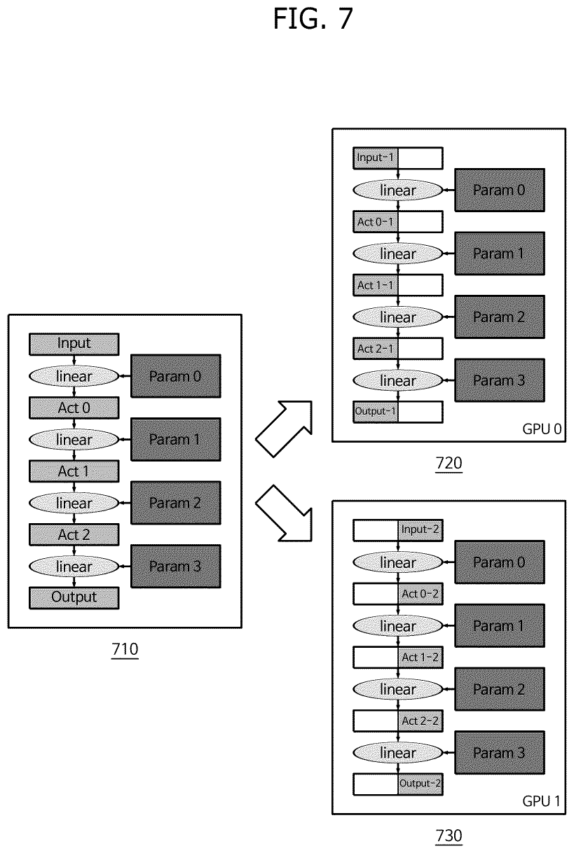

A processor 100 may determine the number of accelerators to process the original call list 110 and create a plurality of sub call lists 120_1 to 120_n based on the determined number of accelerators and the original call list 110. The processor 100 may be included in an information processing system to be described below, and each of the plurality of sub call lists 120_1 to 120_n may be created by changing the original call list 110. In addition, each of the plurality of sub call lists 120_1 to 120_n may include at least one primitive operation. The at least one primitive operation included in the original call list 110 may be included in the sub call lists 120_1 to 120_n. Various examples of dividing the original call list 110 into a plurality of sub call lists 120_1 to 120_n will be described below with reference to FIGS. 7 to 10. The original call list 110 may be divided into a plurality of call lists 120_1 to 120_n based on at least one of the call list parallelization methods described below.

The plurality of primitive operations may include any operations included in the operation library. In this case, the operation library may be a library accessible to a plurality of accelerators 130_1 to 130_n provided by a plurality of manufacturers.

Each of the plurality of sub call lists 120_1 to 120_n may be transmitted to the plurality of accelerators 130_1 to 130_n. One accelerator may receive at least one sub call list. FIG. 1 illustrates that one accelerator receives one sub call list.

Each of the plurality of accelerators 130_1 to 130_n may access the operation library to call and execute a plurality of primitive operations included in the sub call lists 120_1 to 120_n. According to some examples, each of the plurality of accelerators 130_1 to 130_n may call and execute the plurality of primitive operations by compiling the plurality of primitive operations included in the sub call lists 120_1 to 120_n to create binary codes, and executing the created binary codes.

The plurality of accelerators 130_1 to 130_n may transmit result data of performance based on the primitive operations included in the sub call lists 120_1 to 120_n to a predetermined specific accelerator. The result data may include a calculation result value. A specific accelerator may perform an additional calculation based on the received plurality of result data, output result data according to the additional calculation, or share the result data with each of the plurality of accelerators 130_1 to 130_n.

As the original call list 110 is divided into the plurality of sub call lists 120_1 to 120_n, and the plurality of sub call lists 120_1 to 120_n are processed through the plurality of accelerators 130_1 to 130_n, the original call list 110 can be parallelly processed, and accordingly, the processing speed can be enhanced.

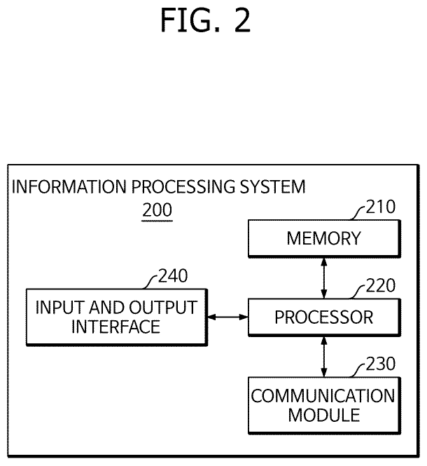

FIG. 2 is a block diagram illustrating an internal configuration of an information processing system 200. The information processing system 200 may include a memory 210, a processor 220, a communication module 230, and an input and output interface 240. The information processing system 200 may be configured to communicate information and/or data through a network using the communication module 230. The processor 220 illustrated in FIG. 2 may correspond to the processor 100 illustrated in FIG. 1.

The memory 210 may include any non-transitory computer-readable recording medium. The memory 210 may include a permanent mass storage device such as read only memory (ROM), disk drive, solid state drive (SSD), flash memory, and so on. In another example, a non-destructive mass storage device such as ROM, SSD, flash memory, disk drive, and so on may be included in the information processing system 200 as a separate permanent storage device that is distinct from the memory. In addition, the memory 210 may store an operating system and at least one program code (e.g., a code for creating, parallelly processing a call list, etc.).

These software components may be loaded from a computer-readable recording medium separate from the memory 210. Such a separate computer-readable recording medium may include a recording medium directly connectable to the information processing system 200, and may include a computer-readable recording medium such as a floppy drive, a disk, a tape, a DVD/CD-ROM drive, a memory card, and the like, for example. In another example, the software components may be loaded into the memory 210 through the communication module 230 rather than the computer-readable recording medium. For example, at least one program may be loaded into the memory 210 based on a computer program (e.g., a program for creating and parallelly processing an original call list, etc.) installed by files provided by developers or a file distribution system that distributes application installation files through the communication module 230.

The processor 220 may be configured to process the commands of the computer program by performing basic arithmetic, logic, and input and output calculations. The commands may be provided to a user terminal (not illustrated) or another external system by the memory 210 or the communication module 230. For example, the processor 220 may transmit a sub call list including at least one primitive operation to the accelerator. The accelerator may be included in the information processing system 200 or may be included in another server or system.

The communication module 230 may provide a configuration or function for the user terminal (not illustrated) and the information processing system 200 to communicate with each other through a network, and may provide a configuration or function for the information processing system 200 to communicate with an external system (e.g., a separate cloud system). For example, control signals, commands, data, and the like provided under the control of the processor 220 of the information processing system 200 may be transmitted to the user terminal and/or the external system through the communication module 230 and the network through the communication module of the user terminal, the external system. For example, the processor 220 may transmit a sub call list to an accelerator included in another server or system through the communication module 230.

In addition, the input and output interface 240 of the information processing system 200 may be a means for interfacing with a device (not illustrated) for inputting or outputting, which may be connected to the information processing system 200 or included in the information processing system 200. In FIG. 2, the input and output interface 240 is illustrated as a component configured separately from the processor 220, but aspects are not limited thereto, and the input and output interface 240 may be configured to be included in the processor 220. The information processing system 200 may include more components than those illustrated in FIG. 2. Meanwhile, most of the related components may not necessarily require exact illustration.

The processor 220 of the information processing system 200 may be configured to manage, process, store the information, data, etc. received from a plurality of user terminals and/or a plurality of external systems. The processor 220 may acquire a trace from the artificial intelligence program and create an original call list including a plurality of primitive operations based on the trace. In addition, the processor 220 may determine the number of accelerators to parallelly process the original call list, and create a plurality of sub call lists based on the determined number of accelerators and the original call list. In addition, the processor 220 may transmit each of the plurality of sub call lists to each of the plurality of accelerators corresponding to the determined number through the communication module 230.

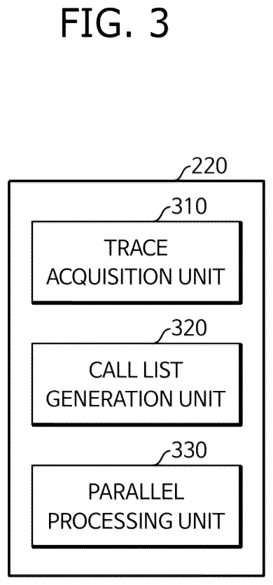

FIG. 3 is a block diagram illustrating an internal configuration of the processor 220. As illustrated in FIG. 3, the processor 220 may include a trace acquisition unit 310, a call list creation unit 320 and a parallel processing unit 330.

The trace acquisition unit 310 may acquire a trace from an artificial intelligence program. The trace acquisition unit 310 may execute an artificial intelligence program, extract a plurality of codes, primitive operations, etc. associated with a calculation, and create a trace including the plurality of extracted codes and/or primitive operations. For example, when the artificial intelligence program is executed, the trace acquisition unit 310 may acquire all codes, all primitive operations, etc. executed through the artificial intelligence program, extract a plurality of codes, primitive operations, etc. associated with calculations from the acquired codes and/or primitive operations, and create a trace including the plurality of extracted codes, primitive operations, etc. The codes, primitive operations, etc. associated with the calculation are those associated with the artificial intelligence calculation performed in the accelerator and may be codes, primitive operations, etc. associated with the operation included in the operation library.

The call list creation unit 320 may create an original call list including a plurality of primitive operations based on the trace created by the trace acquisition unit 310. The primitive operation included in the original call list may not be in the binary form, but may take at least one form of a data structure, serialized data, or text in memory. In addition, the plurality of primitive operations included in the call list may be in the form of a graph. The call list creation unit 320 may represent the call order and correlation of the plurality of primitive operations in a graph form, based on the plurality of primitive operations included in the original call list. An example of the graph representation of the original call list will be described below with reference to FIG. 6.

The parallel processing unit 330 may divide the original call list created by the call list creation unit 320 into a plurality of sub call lists. The parallel processing unit 330 may determine the number of accelerators to parallelly process the original call list, and create a plurality of sub call lists based on the determined number of accelerators and the original call list. The parallel processing unit 330 may determine the number of sub call lists to be created based on the determined number of accelerators. The parallel processing unit 330 may determine, based on a user input, the number of accelerators to parallelly process the original call list. According to some examples, the parallel processing unit 330 may determine the number of accelerators to parallelly process the original call list, based on the maximum number, minimum number, etc. by which at least one of input data, activation, or parameter data may be divided.

The parallel processing unit 330 may divide input data included in the original call list into a plurality of sub input data based on the determined number of accelerators, and create a plurality of sub call lists such that each of the plurality of sub input data is included in each of the plurality of sub call lists. In this case, the parallel processing unit 330 may insert, into each of the plurality of sub call lists, a command for transmitting a calculation result obtained based on each of the plurality of sub call lists to a predetermined specific accelerator and/or a specific processor.

In addition, the parallel processing unit 330 may create a plurality of sub call lists such that the plurality of sub call lists are pipelined and parallelly executed. In this case, the parallel processing unit 330 may insert, into at least one of the first sub call list or the second sub call list, a command for providing output data obtained based on the first sub call list as input data of a primitive operation included in the second sub call list.

In addition, the parallel processing unit 330 may divide parameter data to be applied to each primitive operation included in the original call list into a plurality of sub-parameter data based on the determined number of accelerators, and create a plurality of sub call lists such that each of the plurality of sub parameter data is included in each of the plurality of sub call lists. In this case, the parallel processing unit 330 may insert, into each of the plurality of sub call lists, a first command for transmitting a calculation result obtained based on each of the plurality of sub call lists to a predetermined specific accelerator and/or a specific processor. Additionally, the parallel processing unit 330 may insert, into each of the plurality of sub call lists, a second command for sharing the calculation result obtained through the specific accelerator and/or the specific processor with each of the plurality of accelerators.

The parallel processing unit 330 may determine a plurality of accelerators to parallelly process the original call list based on the positions of the accelerators. For example, accelerator position information including the position of each accelerator may be stored in the information processing system. The position of the accelerator may include zone information of the computer room and/or coordinates associated with a Global Navigation Satellite System (GNSS). The entire area of the computer room may be partitioned into a plurality of areas, and the zone information may include identifiers for the partitioned areas. In addition, the accelerator position information may further include an IP address of the accelerator, a MAC address, a host name, etc.

The parallel processing unit 330 may determine, based on the position of each accelerator included in the accelerator position information, whether a node including the determined number or more of accelerators is searched. The node may herein refer to a physically or logically separated computing device (e.g., a server). If a node including the determined number or more of accelerators is searched, the parallel processing unit 330 may determine, from among all accelerators included in the searched node, a plurality of accelerators to parallelly process the original call list. On the other hand, if determining that a node including the determined number or more accelerators is not searched, the parallel processing unit 330 may determine a plurality of accelerators such that each of the plurality of accelerators to parallelly process the original call list is included in each of a plurality of nodes adjacent to each other.

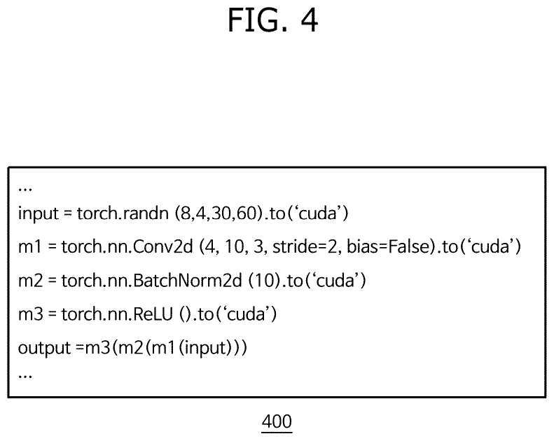

Hereinafter, a method for creating an original call list will be described with reference to FIGS. 4 to 6.

FIG. 4 illustrates an example of a trace 400 acquired from an artificial intelligence program. As illustrated in FIG. 4, a plurality of codes related to calculations may be included in the trace 400. In addition, the trace 400 may include a plurality of primitive operations. FIG. 4 illustrates that a plurality of primitive operations related to convolution (Conv2d) calculation, batch normalization calculation (BatchNorm2d), and ReLU calculation are included in the trace 400, and that input data and output data are additionally included in the trace 400.

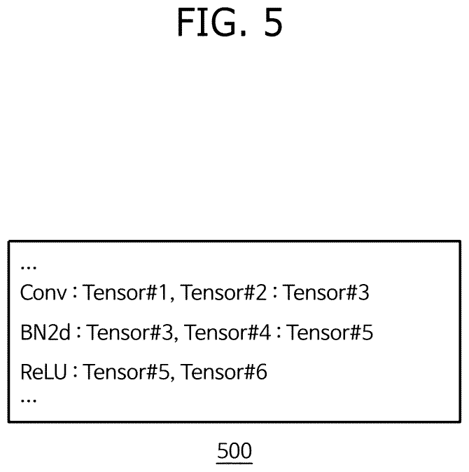

FIG. 5 illustrates an original call list 500. Referring to FIG. 5, the original call list 500 including at least one primitive operation may be created. The original call list 500 may be created based on the trace. For example, by analyzing a plurality of codes included in the trace, a plurality of primitive operations may be extracted from the trace, and a original call list including the plurality of extracted primitive operations may be created. As another example, if the trace includes a plurality of primitive operations, the plurality of primitive operations may be extracted from the trace, and a original call list including the plurality of extracted primitive operations may be created.

The order of primitive operations may be determined based on the execution order of the codes, primitive operations, etc. included in the trace, and input data and output data of primitive operations may be determined based on input data associated with the code and output data associated with the code. FIG. 5 illustrates that the original call list 500 includes a primitive operation (Conv2d) associated with a convolution calculation, a primitive operation (BatchNorm2d) associated with a batch normalization calculation, and a primitive operation (ReLU) associated with a ReLU operation. In addition, it is illustrated that the input data and the output data are determined for each operation. For example, input data of the primitive operation Conv associated with the convolution calculation may be a first tensor (Tensor #1) and a second tensor (Tensor #2), and output data may be a third tensor (Tensor #3).

In addition, operations having a correlation among a plurality of primitive operations included in the original call list 500 may be determined. If the output data of the first primitive operation is input as the input data of the second primitive operation, it may be determined that there is a correlation between the first primitive operation and the second primitive operation. Taking FIG. 5 as an example, it may be determined that the primitive operation (Conv2d) associated with the convolution calculation and the primitive operation (BatchNorm2d) associated with the batch normalization are correlated with each other. As another example, it may be determined that the primitive operation associated with the batch normalization (BatchNorm2d) and the primitive operation associated with the ReLU calculation are correlated with each other. Information on the correlation of primitive operations may be recorded in the original call list 500.

FIG. 6 illustrates an example of a call list represented in the form of a graph 600. The graph 600 illustrated in FIG. 6 may be a graph representation based on the original call list 500 of FIG. 5. As illustrated in FIG. 6, it may be represented in the form of a data flow graph in which primitive operations are sequentially executed from top to bottom. As illustrated in FIG. 6, input data and output data are represented by rectangles, and primitive operations are represented by circles. In addition, the direction of the arrow may relate to data input to the primitive operation or data output from the primitive operation.

A plurality of sub call lists may be created based on the original call list. In addition, a plurality of sub call lists may be transmitted to a plurality of accelerators. Upon receiving the sub call list, the accelerator may access the operation library to call and execute at least one primitive operation included in the sub call list.

Hereinafter, various methods for dividing an original call list into a plurality of sub call lists for parallel processing will be described with reference to FIGS. 7 to 9.

FIG. 7 illustrates first and second sub call lists 720 and 730 associated with parallelization of input data. The first sub call list 720 and the second sub call list 730 may be created based on an original call list 710. The processor may create a plurality of sub call lists 720 and 730 based on the original call list 710 and the number of accelerators to parallelly process the original call list 710.

FIG. 7 illustrates that the original call list 710 includes a plurality of linear transform primitive operations. In FIG. 7, “Act” may indicate activation, and “Param” may indicate parameter data applied to a layer of a machine learning model (e.g., an artificial neural network model). The activation herein is a result of calculation associated with a layer of a machine learning model and may be used as input data of a primitive operation, and the parameter data may be associated with a weight applied to the layer. The parameter data may converge to an optimal value as the machine learning model is repeatedly trained. In addition, ellipses associated with “linear” in FIG. 7 may be primitive operations that perform calculations based on the input data and/or the activation and the parameter data.

When the input data included in the original call list 710 can be divided and calculated, the input data (Input) included in the original call list 710 may be divided into a plurality of sub input data (Input-1, Input-2) as illustrated in FIG. 7. That is, the plurality of sub call lists 720 and 730 may be created such that the input data (Input) included in the original call list 710 is divided into a plurality of sub input data (Input-1, Input-2), and each of the divided plurality of sub input data is included in each of the plurality of sub call lists 720 and 730. For example, the input data (Input) may be divided into first sub-input data (Input-1) and second sub-input data (Input-2), and in this case, first sub input data (Input-1) may be included in the first sub call list 720, and second sub input data (Input-2) may be included in the second sub call list 730.

The input data (input) may be divided into a plurality of pieces of data based on a mini-batch size and processed. For example, the input data (input) may be divided into a plurality of pieces of sub-input data based on the number of accelerators and the size of the mini-batch for parallel processing the original call list 710. For example, if the size of the mini-batch of the input data (input) is “16” and the number of accelerators is “2”, the input data (input) may be divided into first sub-input data (Input-1) and second sub-input data (Input-2) each including 8 mini-batches. If the input data (Input) is divided into sub-input data (Input-1, Input-2) in units of mini-batches, the activations (Act 0 to Act 2) may also be divided into sub-activations (Act 0-1 to Act 2) in units of mini-batches, and additionally, the output data (Output) may also be divided into sub-output data (Output-1, Output-2) in units of batches. If the input data (Input) is divided into sub-input data (Input-1, Input-2), partial calculations based on the sub-input data (Input-1, Input-2) are performed through a machine learning model (e.g., an artificial neural network model, etc.), and the activation (Act) output through the machine learning model may also be divided and output. As illustrated in FIG. 7, the first activation (Act 0) may be divided into a first sub-activation (Act 0-1) and a second sub-activation (Act 0-2), and in this case, the first sub-activation Act 0-1 may be included in the first sub call list 720, and the second sub-activation Act 0-2 may be included in the second sub call list 730. The first sub activation (Act 0-1) may be calculated based on the first sub input data (Input-1), and the second sub activation (Act 0-2) may be calculated based on the second sub input data (Act 0-2).

The number of divisions of the input data and the activation may correspond to the number of accelerators to parallelly process the original call list. For example, if there are (n) number of accelerators to parallelly process the original call list (where n is a natural number greater than or equal to 2), the number of divisions of the input data and the activation may also be (n). The size and number of divided data may be equivalent or differential. For example, if the input data is divided into first sub-input data and second sub-input data, the size of the first sub-input data and the size of the second sub-input data may be the same as each other, or the size of the first sub-input data may be greater or less than the size of the second sub input data. The number of accelerators to parallelly process the original call list 710 may be determined based on user input, or may be determined based on the number by which each of the input data and the activation can be divided.

FIG. 7 illustrates that there are two accelerators to parallelly process the original call list, and accordingly, the input data (Input) and the activation (Act) are divided into two pieces of data and activations. FIG. 7 illustrates that the input data (Input) is divided into the first sub-input data (Input-1) and the second sub-input data (Input-2). Additionally, FIG. 7 illustrates that the first activation (Act 0) is divided into a plurality of sub-activations (Act 0-1 and Act 0-2), and each of the second and third activations (Act 1 and Act 2) is also divided into a plurality of sub-activations (Act 1-1, Act 1-2, Act 2-1 and Act 2-2). Additionally, it is illustrated that the output data (Output) is also divided into first sub-output data (Output-1) and second sub-output data (Output-2).

The first sub call list 720 may include some of the divided input data and activations, and the second sub call list 730 may include the rest of the divided input data and activations. FIG. 7 illustrates that the first sub call list 720 includes first sub input data (Input-1) and a plurality of sub activations (Act 0-1, Act 1-1, and Act 2-1), and the second sub call list 730 may include second sub input data (Input-2) and a plurality of sub activations (Acts 0-2, Act 1-2, and Act 2-2). The first sub-output data (Output-1) may be result data calculated based on the first sub call list 720, and the second sub-output data (Output-2) may be result data calculated based on the second sub call list 730. That is, a plurality of primitive operations associated with each of the first sub input data (Input-1) and the plurality of sub activations (Act 0-1, Act 1-1, and Act 2-1) included in the first sub call list 720 are executed, and the first sub output data (Output-1) may be output. In addition, a plurality of primitive operations associated with each of the first sub input data (Input-2) and the plurality of sub activations (Act 0-2, Act 1-2, and Act 2-2) included in the second sub call list 730 are executed, and the second sub output data (Output-2) may be output.

The first sub call list 720 may be transmitted to the first accelerator (GPU 0), and the second sub call list 730 may be transmitted to the second accelerator (GPU 1), so that primitive operations included in the first sub call list 720 and primitive operations included in the second sub call list 730 may be parallelly executed through the first accelerator (GPU 0) and the second accelerator (GPU 1). The dividing the input data and the activation described above may be performed by one or more processors included in the information processing system.

The results of execution through the first accelerator (GPU 0) and the second accelerator (GPU 1) may be aggregated by a specific accelerator and/or a specific processor. The one or more processors included in the information processing system may insert, into each of the plurality of sub call lists 720 and 730, a command for transmitting the calculation result obtained based on each of the plurality of sub call lists 720 and 730 to a predetermined specific accelerator and/or specific processor. Based on the inserted command, each of the accelerators GPU 0 and GPU 1 may transmit the calculation result generated based on the sub call lists 720 and 730 to the specific accelerator and/or one or more processors. In addition, the specific accelerator and/or specific processor may be configured to create output data (e.g., calculation result) associated with the original call list based on the calculation result received from each of the plurality of accelerators GPU 0 and GPU1.

For example, the second accelerator (GPU 1) may execute all primitive operations included in the second sub call list 730 and transmit the acquired second sub output data (Output-2) to the first accelerator (GPU 0). In this case, the first accelerator (GPU 0) may create final result data based on the first sub output data (Output-1) acquired by executing all primitive operations included in the first sub call list 720 and the second sub output data (Output-2) received from the second accelerator (GPU 1). The final result data may be a value associated with a gradient. For example, if the first sub-output data (Output-1) received from the first accelerator (GPU 0) is associated with a first gradient and the second sub-output data (Output-2) received from the second accelerator (GPU 1) is associated with a second gradient, the first and second gradients may be reflected and the final result data may be acquired.

In some examples, the results (Output-1, Output-2) of execution through the first accelerator (GPU 0) and the second accelerator (GPU 1) may be subsequently processed without being aggregated in a specific accelerator. For example, the sub-output data (Output-1, Output-2) created through each of the first accelerator (GPU 0) and the second accelerator (GPU 1) may be stored in a memory of a specific accelerator. In this case, the specific accelerator may create final result data based on the sub output data (Output-1, Output-2) stored in its memory. As another example, the sub-output data (Output-1, Output-2) created through each of the first accelerator (GPU 0) and the second accelerator (GPU 1) may be stored in the main memory of the information processing system. In this case, the processor included in the information processing system may create final result data based on the sub output data (Output-1, Output-2) stored in the main memory. As still another example, the first sub-output data (Output-1) created through the first accelerator (GPU 0) may be managed by the first accelerator (GPU 0) without being transmitted to another accelerator or memory, and similarly, the second sub-output data (Output-2) created through the second accelerator (GPU 1) may also be managed by the second accelerator (GPU 1) without being transmitted to another accelerator or memory. In this case, the first sub-output data (Output-1) and the second sub-output data (Output-2) may be continuously maintained in the divided state.

Meanwhile, a target accelerator to transmit the plurality of sub call lists 720 and 730 to may be determined based on the position of the accelerator. In order to minimize communication delay during aggregation of the output data, the target accelerator to transmit the plurality of call lists 720 and 730 to may be determined such that the first accelerator (GPU 0) and the second accelerator (GPU 1) receiving the sub call lists 720 and 730 are included in the same node. The node may herein refer to a physically or logically separated computing device (e.g., a server, a user terminal, etc.) If a plurality of accelerators included in the same node are not retrieved, the target accelerators to transmit the plurality of sub call lists 720 and 730 to may be determined such that the first node including the first accelerator (GPU 0) and the second node including the second accelerator (GPU 1) are located adjacent to each other. In this case, the first node may be a neighbor node to the second node.

As described above, a plurality of sub call lists 720 and 730 to parallelly process the original call list 710 may be created. Each of the plurality of sub call lists 720 and 730 is transmitted to a plurality of accelerators (GPU 0 and GPU 1), and each primitive operation included in the plurality of sub call lists 720 and 730 may be executed in parallel. If a plurality of accelerators are used for the parallel processing of data, the calculation speed may be further improved.

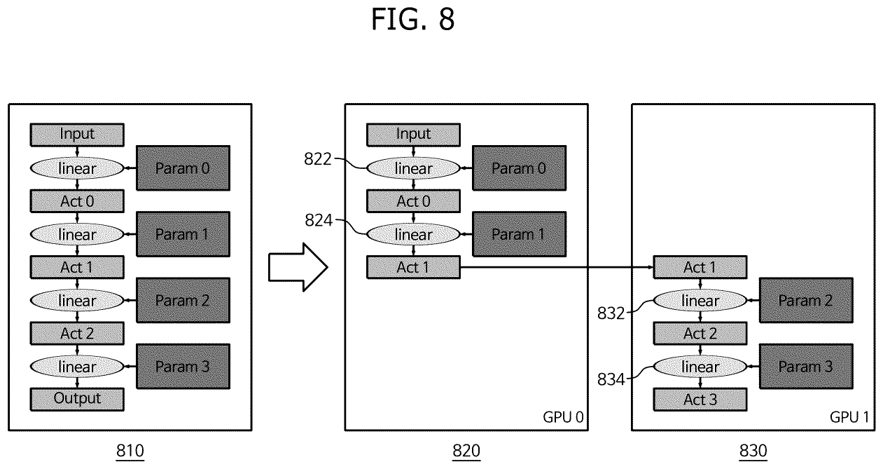

FIG. 8 illustrates first and second sub call lists 820 and 830 associated with pipelining. The first sub call list 820 and the second sub call list 830 may be created based on an original call list 810. The processor may create a plurality of sub call lists 820 and 830 based on the original call list 810 and the number of accelerators to parallelly process the original call list 810.

FIG. 8 illustrates that the original call list 810 includes a plurality of linear transform primitive operations. In FIG. 8, “Act” may indicate activation, and “Param” may indicate parameter data applied to a layer of a machine learning model. The activation is a result of calculation associated with a layer of a machine learning model (e.g., artificial neural network model) and may be used as input data of a primitive operation, and the parameter data may be associated with a weight applied to the layer. In addition, ellipses associated with “linear” in FIG. 8 may be primitive operations that perform calculations based on the input data and/or the activation and the parameter data.

When there are a plurality of accelerators that process the original call list 810, the original call list 810 may be divided into the plurality of sub call lists 820 and 830, as illustrated in FIG. 8. That is, the plurality of sub call lists 820 and 830 may be created such that the primitive operations included in the original call list 810 are divided into a plurality of groups, and each of the primitive operations of the divided groups is included in each of the plurality of sub call lists 820 and 830. For example, the plurality of primitive operations included in the original call list 810 may be divided into a first subgroup and a second subgroup, and the first sub call list 820 including the primitive operations included in the first subgroup and the second sub call list 830 including the primitive operations included in the second subgroup may be created. The first sub call list 820 and the second sub call list 830 may be transmitted to different accelerators, respectively. FIG. 8 illustrates that the first sub call list 820 is transmitted to the first accelerator (GPU 0), and the second sub call list 830 is transmitted to the second accelerator (GPU 1).

Pipelining may be performed between the first sub call list 820 and the second sub call list 830. For pipelining, a command may be inserted into at least one of the first sub call list 820 or the second sub call list 830 such that result data output through the primitive operations included in the first sub call list 820 are provided as input data of the primitive operations included in the second sub call list 830. For example, a command associated with providing the result data may be inserted into the first sub call list 820 such that the data output through the last executed primitive operation of the primitive operations included in the first sub call list 820 is provided as the input data of the first executed primitive operation of the primitive operations included in the second sub call list 830. The command associated with providing the result data may be a command for transmitting data output through the last executed primitive operation of the primitive operations included in the first sub call list 820 to the second accelerator (GPU 1). In this case, if the output data obtained based on the first sub call list 820 is received, the second accelerator (GPU 1) may sequentially execute the primitive operations included in the second sub call list 830.

As illustrated in FIG. 8, a first primitive operation 822 and a second primitive operation 824 may be included in the first sub call list 820, and a third primitive operation 832 and a fourth primitive operation 834) may be included in the second sub call list 830.

A first command for transmitting result data (Act 1) output from the second primitive operation 824 to the second accelerator (GPU 1) may be inserted into the second sub call list 830. Additionally or alternatively, a second command for receiving result data (Act 1) of the second primitive operation 824 from the first accelerator (GPU 0) may be inserted into the second sub call list 830. The inserting the command and dividing the primitive operation described above may be performed by one or more processors included in the information processing system.

Meanwhile, a target accelerator to transmit the plurality of sub call lists 820 and 830 to may be determined based on the position of the accelerator. In order to minimize a communication delay between accelerators based on the commands inserted in the sub call lists 820 and 830, a target accelerator to transmit the plurality of sub call lists 820 and 830 to may be determined such that the first accelerator (GPU 0) and the second accelerator (GPU 1) that communicate with each other through the inserted commands are included in the same node. The node may herein refer to a physically or logically separated computing device (e.g., a server, a user terminal, etc.)

If a plurality of accelerators included in the same node are not retrieved, the target accelerators to transmit the plurality of sub call lists 820 and 830 to may be determined such that the first node including the first accelerator (GPU 0) and the second node including the second accelerator (GPU 1) are located adjacent to each other. In this case, the first node may be a neighbor node to the second node.

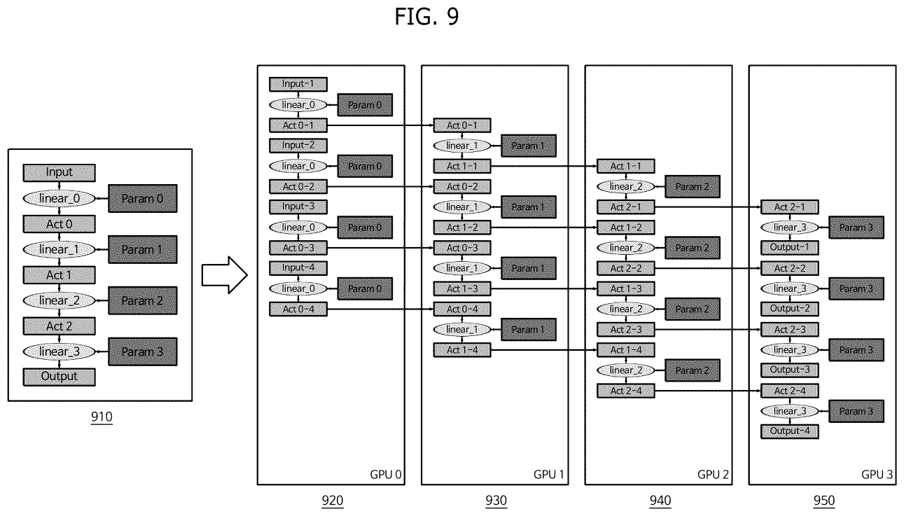

FIG. 9 illustrates first to fourth sub call lists 920 to 940 associated with pipelining. The first to fourth sub call lists 920 to 950 may be created based on an original call list 910. The processor may create a plurality of sub call lists 920 to 950 based on the original call list 910 and the number of accelerators to parallelly process the original call list 910. The sub call lists 920 to 950 illustrated in FIG. 9 may be associated with pipeline parallelism for four accelerators (GPU 0 to GPU 3).

FIG. 9 illustrates that the original call list 910 includes a plurality of linear transform primitive operations. In FIG. 9, “Act” may indicate activation, and “Param” may indicate parameter data applied to a layer of a machine learning model. In addition, ellipses associated with “linear” in FIG. 9 may be primitive operations that perform calculations based on the input data and/or the activation and the parameter data.

The input data (input) may be divided into a plurality of pieces of sub-input data in units of batches and processed. FIG. 9 illustrates that the input data (input) is divided into sub-input data (input-1 to input-4) of four batch units. If input data (Input) is divided into sub-input data (Input-1 to Input-4), activations (Act 0 to Act 2) may also be divided into a plurality of sub-activations (Act 0-1 to Act 2-4) in units of batches, and additionally, output data (Output) may also be divided into a plurality of sub-output data (Output-1 to Output-4) in units of batches. As illustrated in FIG. 9, at least one of a plurality of primitive operations (linear_0 to linear_3) may be included in the sub call lists 920 to 950. FIG. 9 illustrates that the first sub call list 920 includes a first primitive operation (linear_0), the second sub call list 930 includes a second primitive operation (linear_1), the third sub call list 940 includes a third primitive operation (linear_2), and the fourth sub call list 950 includes a fourth primitive operation (linear_3).

Two or more of the sub call lists 920 to 950 may be pipelined. FIG. 9 illustrates that the first sub call list 920 and the second sub call list 930 are pipelined, the second sub call list 930 and the third sub call list 940 are pipelined, and the third sub call list 940 and the fourth sub call list 950 are pipelined.

For pipelining, a command may be inserted into at least one of the first sub call list 920 or the second sub call list 930 such that result data output through the primitive operations included in the first sub call list 920 are provided as input data of the primitive operations included in the second sub call list 930. For example, a command associated with providing the result data may be inserted into the first sub call list 920 such that each of the data (Acts 0-1 to Act 0-4) output through the first primitive operation (linear_0) included in the first sub call list 920 is provided as input data of the primitive operation (linear_1) included in the second sub call list 930. The command associated with providing the result data may be a command for transmitting data output through the first primitive operation (linear_0) included in the first sub call list 920 to the second accelerator (GPU 1).

Likewise, a command associated with providing the result data may be inserted into the second sub call list 930 such that each of the data (Acts 1-1 to Act 1-4) output through the second primitive operation (linear_1) included in the second sub call list 930 is provided as input data of the primitive operation (linear_2) included in the third sub call list 940. In addition, a command associated with providing the result data may be inserted into the third sub call list 940 such that each of the data (Acts 2-1 to Act 2-4) output through the third primitive operation (linear_2) included in the third sub call list 940 is provided as input data of the fourth primitive operation (linear_3) included in the fourth sub call list 950.

As illustrated in FIG. 9, the sub call lists 920 to 950 may be transmitted to a plurality of accelerators (GPU 0 to GPU 3), and the plurality of sub call lists 920 to 950 may be processed in parallel through the plurality of accelerators (GPU 0 to GPU 3).

Meanwhile, FIG. 9 illustrates that one accelerator (GPU 0 to GPU 3) executes one primitive operation, but aspects are not limited thereto, and one accelerator may execute a plurality of primitive operations and transmit results output through each of the plurality of operations to another accelerator. The number of primitive operations to be allocated to a specific accelerator of a plurality of primitive operations may be determined based on at least one of performance or state of the accelerator. For example, if an accelerator has a large throughput, a large memory capacity, or a low utilization rate, a sub call list including a larger number of primitive operations may be transmitted to the accelerator.

As described above, if the sub call lists 920 to 950 are processed through a plurality of accelerators, the entire computing resources of the information processing system can be managed more efficiently. For example, based on the pipeline, the plurality of sub call lists 920 to 950 may be processed in parallel through a plurality of accelerators, thereby increasing the throughput of the accelerator per unit time and shortening the total calculation time. In addition, since the whole calculation is divided into small calculations and processed in parallel through a plurality of accelerators, memory resources used by each of the plurality of accelerators may be reduced. In addition, the divided sub call lists 920 to 950 are allocated to the accelerators with low load and processed, so that the number of accelerators in an idle state can be minimized.

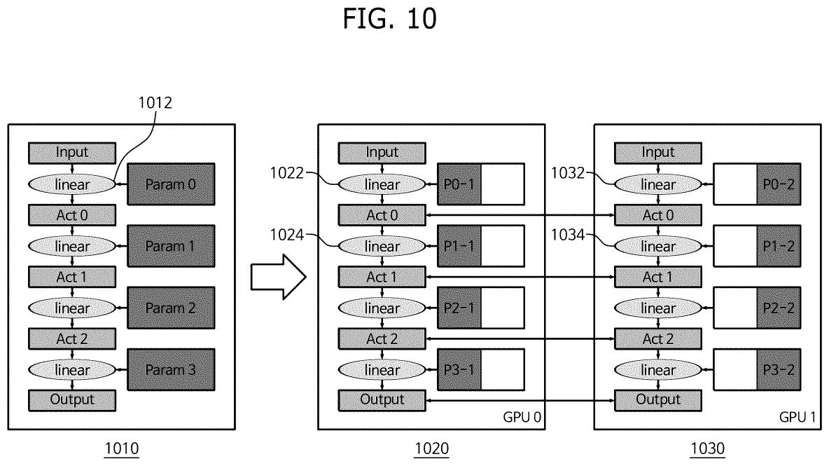

FIG. 10 illustrates first and second sub call lists 1020 and 1030 associated with parameter data parallel processing. The first sub call list 1020 and the second sub call list 1030 may be created based on an original call list 1010. The processor may create a plurality of sub call lists 1020 and 1030 based on the original call list 1010 and the number of accelerators to parallelly process the original call list 1010.

FIG. 10 illustrates that the original call list 1010 includes a plurality of linear transform primitive operations. In FIG. 10, “Act” may indicate activation, and “Param” may indicate parameter data applied to a layer of a machine learning model. The activation is a result of calculation associated with a layer of a machine learning model (e.g., artificial neural network model) and may be used as input data of a primitive operation, and the parameter data may be associated with a weight applied to the layer. The parameter data may converge to an optimal value as the machine learning model is repeatedly trained. In addition, ellipses associated with “linear” in FIG. 10 may be primitive operations that perform calculations based on the input data and/or the activation and the parameter data.

Each parameter data may include a plurality of parameters. The plurality of parameters may be a plurality of weights applied to nodes included in a specific layer. Each of the plurality of weights may be, in a calculation, weights that are applied to variables (e.g., input values) and/or constants.

The number by which the parameter data is divided may be determined based on the number of accelerators to parallelly process the original call list 1010, and the parameter data may be divided by the determined number based on the determined number. For example, the parameter data may be divided into a plurality of sub-parameters based on the determined number. Each of a plurality of parameters applied to each of a plurality of primitive operations may be divided by the determined number. The divided parameter data may include equivalent or differential numbers of parameters.

The plurality of sub call lists 1020 and 1030 including each of the divided sub parameter data may be created. FIG. 10 illustrates that each of a plurality of parameter data (Param 0 to Param 3) is divided into two pieces of data. That is, it is illustrated that the first parameter data (Param 0) is divided into two pieces of sub-parameter data (P0-1, P0-2), and the other parameter data (Param 1 to Param 3) is also divided into two pieces of sub-parameter data (P1-1, P1-2, P2-1, P2-2, P3-1, P3-2). In addition, it is illustrated that the sub-parameter data (P0-1, P1-1, P2-1, and P3-1) corresponding to the first group of divided sub-parameter data are included in the first sub call list 1020, and a plurality of sub-parameter data (P0-1, P1-1, P2-1, and P3-1) corresponding to the second group are included in the second sub call list 1030.

If an operation is performed using the divided sub parameter data, only a part of the primitive operations may be performed in a specific accelerator. For example, if the first accelerator (GPU 0) executes a first primitive operation 1022 included in the first sub call list 1020, the first accelerator (GPU 0) may only perform a calculation based on the first sub-parameter data (P0-1), but may not be able to perform a calculation based on the second sub-parameter data (P0-2). Similarly, if the second accelerator (GPU 1) executes a first primitive operation 1032 included in the second sub call list 1030, the second accelerator (GPU 1) may only perform a calculation based on the second sub-parameter data (P0-2), but may not be able to perform a calculation based on the first sub-parameter data (P0-1).

Accordingly, the result data of the first primitive operation 1022 executed by the first accelerator (GPU 0) and the result data of the first primitive operation 1032 executed by the second accelerator (GPU 1) should be aggregated to execute an original primitive operation 1012 normally. For example, in the original primitive operation 1012, it can be assumed that the calculation is “Act 0=(a*input)−(b*input)”, where “a” is the first sub-parameter (P0-1), and “b” is the second sub-parameter P0-2”. In this case, the result data of the first primitive operation 1022 executed by the first accelerator (GPU 0) may be calculated based on “(a*input)”, and the result data of the first primitive operation 1032 executed by the second accelerator (GPU 1) may be calculated based on “(b*input)”. In order to calculate a final value for “Act 0” by partially performing the calculation, the partially calculated result data in one accelerator should be transmitted to another accelerator and/or processor.

A command for sharing the calculation result with each accelerator (or processor) may be inserted into the sub call list. For example, a master accelerator may be determined from among a plurality of accelerators to which the sub call list is transmitted. For example, after determining the state of the accelerator to which the call list is transmitted, the accelerator with the lowest utilization rate may be determined to be the master accelerator, and the rest may be determined to be slave accelerators. In some examples, among a plurality of accelerators included in the information processing system, an accelerator to which the sub call list is not transmitted may be determined to be a master accelerator.

At least one command for transmitting a calculation result of a primitive operation to the master accelerator may be inserted into the sub call list transmitted to the slave accelerator. If a calculation for the primitive operation is completed based on the inserted command, the slave accelerator may immediately transmit the completed calculation result to the master accelerator. The calculation result should be transmitted from the slave accelerator to the master accelerator in real time because it is necessary to minimize a delay time for the primitive operation that is linearly performed in the master accelerator.

The master accelerator may calculate a final calculation result of the original primitive operation based on the calculation result of the directly executed primitive operation and the calculation result of the primitive operation received from the slave accelerator. In addition, a command for transmitting the final calculation result to the slave accelerator may be inserted into the sub call list transmitted to the master accelerator.

Referring to FIG. 10 as an example, if the first accelerator (GPU 0) is the master accelerator, at least one command for transmitting the calculation result of each primitive operation to the first accelerator (GPU 0) may be inserted into the second sub call list 1030 transmitted to the second accelerator (GPU 1). In addition, a command for transmitting the final calculation result of the primitive operation to the second accelerator (GPU 1) may be inserted into the first sub call list 1020 transmitted to the first accelerator (GPU 0).

Based on the inserted command, the first accelerator (GPU 0) may receive a calculation result of the first primitive operation 1032 included in the second sub call list 1030 from the second accelerator (GPU 1). In addition, the first accelerator (GPU 0) may calculate the final calculation result (Act 0) of the first primitive operation 1012 based on the partial calculation result of the first primitive operation 1022 included in the first sub call list 1020 and the partial calculation result of the first primitive operation 1032 received from the second accelerator (GPU 1), and transmit the calculated final calculation result (Act 0) to the second accelerator (GPU 1) for sharing.

The first accelerator (GPU 0) may perform a second primitive operation 1024 included in the first sub call list 1020 based on the final calculation result (Act 0), and the second accelerator (GPU 1) may perform a second primitive operation 1034 included in the second sub call list 1030 based on the final calculation result (Act 0). The calculation result of the second primitive operation 1034 may be received by the first accelerator GPU 0 as the master accelerator. The first accelerator (GPU 0) may perform a final calculation on the second primitive operation based on the received partial calculation result on the second primitive operation 1034 and the partial calculation result on the second primitive operation 1024 included in the first sub call list 1020. The inserting the command and dividing the parameter data described above may be performed by one or more processors included in the information processing system.

Meanwhile, a target accelerator to transmit the plurality of sub call lists 1020 and 1030 to may be determined based on the position of the accelerator. The first accelerator (GPU 0) and the second accelerator (GPU 1) receiving the sub call lists 1020 and 1030 may each be included in the same node or adjacent nodes such that communication delay between the accelerators can be minimized.

As described above, each of the plurality of sub call lists 1020 and 1030 is transmitted to a plurality of accelerators (GPU 0 and GPU 1), and each primitive operation included in the plurality of sub call lists 1020 and 1030 may be parallelly executed. If such parallel processing is performed, calculation speed can be further improved. In addition, since the calculation of the accelerator is performed based on some of the parameter data, memory resources used by the accelerator may be reduced.

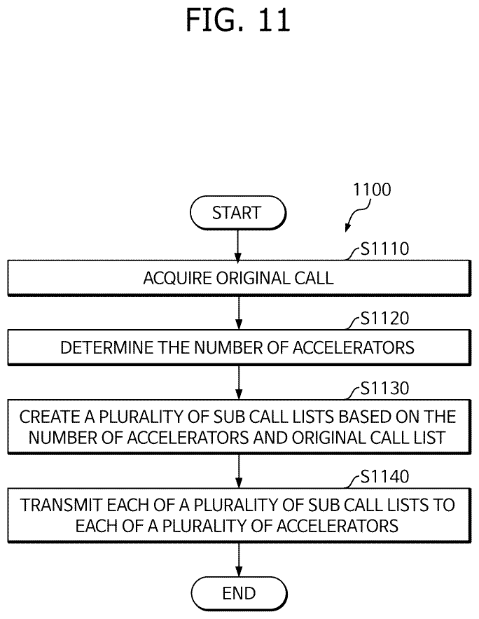

FIG. 11 is a flowchart illustrating a method 1100 for parallelly processing a call list associated with an artificial intelligence calculation. The method 1100 illustrated in FIG. 11 is merely one example for achieving the object of the present disclosure, and it goes without saying that certain steps may be added or deleted as needed. In addition, the method 1000 illustrated in FIG. 11 may be performed by one or more processors included in the information processing system. For convenience of description, it will be described that each step illustrated in FIG. 11 is performed by a processor included in the information processing system.

The processor may acquire an original call list including a plurality of primitive operations, at S1110. The processor may acquire a trace from the source program including the artificial intelligence calculation, and acquire the original call list based on the trace. In this case, the processor may execute the source program to acquire at least one code and/or primitive operation associated with the artificial intelligence calculation, and acquire a trace including the acquired at least one code and/or primitive operation. The plurality of primitive operations may be included in an operation library accessible to each of the plurality of accelerators.

The processor may determine the number of accelerators to parallelly process the original call list, at S1120.

The processor may create a plurality of sub call lists based on the determined number of accelerators and the original call list, at S1130.

For example, the processor may divide input data included in the original call list into a plurality of sub input data based on the determined number of a plurality of accelerators, and create a plurality of sub call lists such that each of the divided plurality of sub input data is included in each of the plurality of sub call lists. In this case, the processor may insert, into each of the plurality of sub call lists, a command for transmitting the calculation result obtained based on each of the plurality of sub call lists to a predetermined specific accelerator. In addition, the specific accelerator may be configured to receive, from each of the plurality of accelerators, a calculation result obtained based on each of the plurality of sub call lists, and create output data associated with the original call list based on the calculation result received from each of the plurality of accelerators.

As another example, the processor may create a plurality of sub call lists such that the plurality of sub call lists are pipelined. In this case, the processor may insert, into at least one of the first sub call list or the second sub call list, a command for providing the output data obtained based on the first sub call list as input data of a primitive operation included in the second sub call list.

As another example, the processor may divide the parameter data applied to each of the primitive operations included in the original call list based on the determined number of a plurality of accelerators, and create a plurality of sub call lists such that each of the divided parameter data is included in each of the plurality of sub call lists. In this case, the processor may insert, into each of the plurality of sub call lists, a first command for transmitting a calculation result obtained based on each of the plurality of sub call lists to a predetermined specific accelerator, and insert, into each of the plurality of sub call lists, a second command for sharing the calculation result obtained by the determined specific accelerator with each of the plurality of accelerators.

The processor may transmit each of the plurality of created sub call lists to each of the plurality of accelerators corresponding to the determined number, at S1140. The processor may determine a plurality of accelerators to which each of the plurality of sub call lists is to be transmitted, based on the position of each accelerator included in the accelerator position information. For example, the processor may determine, based on the position of each accelerator included in the accelerator position information, whether a node including the determined number or more of accelerators is searched. If a node including the determined number or more of accelerators is searched, the processor may determine, from among all accelerators included in the searched nodes, a plurality of accelerators to which each of the plurality of sub call lists is to be transmitted. On the other hand, if it is determined that a node including the determined number or more of accelerators is not searched, the processor may determine a plurality of accelerators to which each of the plurality of sub call lists is to be transmitted such that each of the plurality of accelerators is included in each of a plurality of adjacent nodes.

Meanwhile, one or more of the plurality of parallelization methods (e.g., the parallelization methods associated with FIGS. 7 to 11) according to various examples described above may be applied to the original call list, and a plurality of sub call lists may be created based on the one or more parallelization methods. In addition, a plurality of created sub call lists may be transmitted to a plurality of accelerators.

The flowchart and description described above are merely examples, and may be implemented differently in some examples. For example, in some examples, the order of respective steps may be changed, some steps may be repeatedly performed, some steps may be omitted, or some steps may be added.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or marking data storage devices, etc. The instructions may be executable by one or more processors, and may cause the processor(s) to perform certain aspects of the functions described in the present disclosure.

If implemented in software, the techniques described above may be stored on a computer-readable medium as one or more instructions or codes, or may be sent via a computer-readable medium. The computer-readable media include both the computer storage media and the communication media including any medium that facilitates the transmission of a computer program from one place to another. The storage media may also be any available media that may be accessible to a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessible to a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

1. A method performed by one or more processors, the method comprising:
obtaining an original call list comprising a plurality of primitive operations, wherein the original call list is associated with an artificial intelligence calculation;
determining a plurality of accelerators to parallelly process the original call list;
generating, based on the original call list and based on a quantity of the plurality of accelerators, a plurality of sub call lists; and
transmitting each of the plurality of sub call lists to a corresponding one of the plurality of accelerators.

2. The method according to claim 1, wherein the generating the plurality of sub call lists comprises:
dividing, based on the quantity of the plurality of accelerators, input data comprised in the original call list into a plurality of pieces of sub input data; and
generating the plurality of sub call lists such that each of the plurality of pieces of sub input data is comprised in a corresponding one of the plurality of sub call lists.

3. The method according to claim 2, wherein the generating the plurality of sub call lists comprises inserting, into each of the plurality of sub call lists, a command for transmitting a calculation result obtained based on a corresponding one of the plurality of sub call lists to a specific accelerator, and
wherein the specific accelerator is configured to receive, from each of the plurality of accelerators, the calculation result obtained based on the corresponding one of the plurality of sub call lists, and to generate, based on the calculation result received from each of the plurality of accelerators, output data associated with the original call list.

4. The method according to claim 1, wherein the generating the plurality of sub call lists comprises generating the plurality of sub call lists such that the plurality of sub call lists are pipelined.

5. The method according to claim 4, wherein the plurality of sub call lists comprise a first sub call list and a second sub call list, and
wherein the generating the plurality of sub call lists comprises inserting, into at least one of the first sub call list or the second sub call list, a command for providing output data obtained based on the first sub call list as input data of a primitive operation comprised in the second sub call list.

6. The method according to claim 1, wherein the generating the plurality of sub call lists comprises:
dividing, based on the quantity of the plurality of accelerators, parameter data applied to each of the plurality of primitive operations comprised in the original call list; and
generating the plurality of sub call lists such that each of the divided parameter data is comprised in a corresponding one of the plurality of sub call lists.

7. The method according to claim 6, wherein the generating the plurality of sub call lists comprises:
inserting, into each of the plurality of sub call lists, a first command for transmitting a calculation result obtained based on a corresponding one of the plurality of sub call lists to a specific accelerator; and
inserting, into each of the plurality of sub call lists, a second command for sharing the calculation result obtained by the specific accelerator with each of the plurality of accelerators.

8. The method according to claim 1, wherein the transmitting each of the plurality of sub call lists comprises determining, based on a position of each accelerator comprised in accelerator position information, the plurality of accelerators to which a corresponding one of the plurality of sub call lists is to be transmitted.

9. The method according to claim 8, wherein the determining the plurality of accelerators comprises:
determining, based on the position of each accelerator comprised in the accelerator position information, whether a node comprising the quantity or more of accelerators is identified; and
based on a node comprising the quantity or more of accelerators being identified, determining, from among all accelerators comprised in the identified node, the plurality of accelerators to which a corresponding one of the plurality of sub call lists is to be transmitted.

10. The method according to claim 9, further comprising:
based on a determination that a node comprising the quantity or more of accelerators being not identified, determining the plurality of accelerators to which a corresponding one of the plurality of sub call lists is to be transmitted such that the plurality of accelerators are comprised in a plurality of adjacent nodes.

11. The method according to claim 1, wherein the obtaining the original call list comprises:
obtaining a trace from a source program comprising an artificial intelligence calculation, wherein the trace comprises at least one of:
a code associated with the source program; or
a primitive operation associated with the source program; and
obtaining, based on the trace, the original call list,
wherein the plurality of primitive operations are comprised in an operation library accessible to each of the plurality of accelerators.

12. The method according to claim 11, wherein the obtaining the trace comprises:
obtaining, by executing the source program, at least one of the code or the primitive operation associated with the source program; and
obtaining the trace, wherein the trace comprises the at least one of the code or the primitive operation associated with the source program.

13. A non-transitory computer-readable medium storing instructions that, when executed, cause performance of the method of claim 1.

14. An information processing system, comprising:
one or more processors; and
memory storing instructions that, when executed by the one or more processors, cause the information processing system to:
obtain an original call list comprising a plurality of primitive operations, wherein the original call list is associated with an artificial intelligence calculation;
determine a plurality of accelerators to parallelly process the original call list;
generate, based on the original call list and based on a quantity of the plurality of accelerators, a plurality of sub call lists; and
transmit each of the plurality of sub call lists to a corresponding one of the plurality of accelerators.
